(19) United States
(12) Patent Application Publication
(10) Pub. No.: US 2020/0242654 A1
(43) Pub. Date: Jul. 30, 2020

(54) MERCHANDISE SALES SYSTEM AND OPERATION METHOD THEREOF

(71) Applicant: Wei Ling CHEN, Taichung City (TW)

(72) Inventor: Hsin-Yu CHEN, Taichung City (TW)

(21) Appl. No.: 16/256,368

(22) Filed: Jan. 24, 2019

(51) Int. Cl. G06Q 30/02; G06Q 10/08; G06Q 30/06

(52) U.S. Cl. CPC G06Q 30/0234; G06Q 30/0601; G06Q 30/0222; G06Q 10/083

(57) ABSTRACT

A merchandise sales system and an operation method thereof are provided. When a consumer purchases any one of plurality of product items on a merchandise transacting module and acquires a corresponding product, a sharing module generates a merchandise sharing code comprising a purchase website including an identification code linked to the consumer who purchased the product item. The purchase website is directed to a transaction website, and the merchandise sharing code is acquired by the consumer along with the product. When the merchandise transacting module detects that another potential consumer enters the transaction website through the purchase website shared by the consumer through scanning the merchandise sharing code and purchases the product item, a profit sharing module rebates a cashback amount according to the identification code to the consumer linked to the identification code.

### FIELD OF THE INVENTION

The present invention relates to merchandise sales, and particularly to a merchandise sales system and an operation method thereof.

### BACKGROUND OF THE INVENTION

With the rising of online shopping, merchandise sales patterns and trends have evolutionally changed. For example, the Taiwan Patent No. 1526964, “Advertisement Marketing Method for electronic commerce (E-commerce) and System Thereof”, discloses that identification information of an advertising terminal is included in a web address, and when a consumer terminal connects to a shopping web site directed by a server using a Uniform Resource Locator (URL) alias provided by the advertising terminal, the server generates a merchandise checkout webpage according to an order list and calculates referral fee data corresponding to the order list, such that the advertising terminal is accordingly awarded a corresponding referral fee.

In the above marketing approach, any individual acts as an advertising terminal. On the basis of a mindset of sharing good things with good friends, any normal individual shares a website of a product what he thinks is good, in a social community within the circle of friends. Thus, while introducing good merchandise, the individual is awarded a referral fee. Further, for Internet celebrities, the merchandise and a corresponding website are shared in a personal blog or a personal website. Such recommended purchase program is an effective marketing approach quite favored and promoted by dealers.

In the above marketing approach, an advertising terminal has a chance to be awarded a referral fee by merely sharing a website including identification information of an advertising terminal. However, driven by benefits, a user acting as an advertising terminal shares a website in an unrestrained manner under the premise that the user in fact has not used the merchandise at all. In the long run, general consumers consider such shared website by an advertising terminal as a disturbing Internet advertisement, which is likely to fail in achieving an intended and expected benefit but also cause a collapse in the circle of friends of the advertising terminal.

### SUMMARY OF THE INVENTION

It is a primary object of the present invention to provide a merchandise sales system and an operation method thereof, in which a consumer shares and is awarded a corresponding referral fee, given that the consumer has indeed purchased the product.

To achieve the above object, the present invention provides a merchandise sales system for a consumer to selectively purchase a plurality of products, wherein the plurality of products are shipped by a provider. The merchandise sales system includes a merchandise transacting module, a sharing module, a shipping module and a profit sharing module. The merchandise transacting module includes a plurality of product items corresponding to the plurality of products, and generates a shipping message after the consumer selectively purchases one of the plurality of product items. The sharing module, connected to the merchandise transacting module, is notified by the merchandise transacting module after the consumer purchases the product item, and generates a merchandise sharing code for the purchased product item. The merchandise sharing code comprises a purchase web site including an identification code, the identification code is linked to the consumer who purchased the product item, the purchase website is directed to a transaction website, and the merchandise sharing code is acquired by the consumer along with the product.

The shipping module, connected to the merchandise transacting module, receives the shipping message and provides the shipping message to the provider, so as to ship according to the shipping message and deliver the corresponding product to the consumer. After the consumer acquires the merchandise sharing code, the purchase website is shared with another potential consumer by scanning the merchandise sharing code with a personal mobile device. The profit sharing module is connected to the merchandise transacting module. When the merchandise transacting module detects that another potential consumer enters the transaction website through the purchase website and purchases the product item, the merchandise transacting module transmits the identification code included in the purchase website to the profit sharing module, and the profit sharing module rebates a cashback amount according to the identification code to the consumer linked to the identification code.

The present invention further provides an operation method of the foregoing merchandise sales system comprising the following steps.

Step S1, generating shipping information. After the consumer purchases one of the plurality of the product items on the transaction website, the merchandise transacting module generates the shipping message.

Step S2, generating a merchandise sharing code. The merchandise transacting module notifies the sharing module to generate the merchandise sharing code.

Step S3, sharing the purchase website. The merchandise transacting module provides the shipping message to the provider, so as to deliver the corresponding product to the consumer, and to have the merchandise sharing code be acquired by the consumer in order to allow the consumer acquired the merchandise sharing code to share the purchase web site by scanning the merchandise sharing code by the personal mobile apparatus.

Step S4, sharing a profit. The merchandise transacting module continuously detects whether another potential consumer enters the transaction website through the purchase web site and purchases the product item. When another potential consumer enters the transaction website through the purchase website and purchases the product item, the merchandise transacting module transmits the identification code included in the purchase website to the profit sharing module, and the profit sharing module rebates the cashback amount according to the identification code to the consumer linked to the identification code.

As described above, according to the system and the method provided by the present invention, a consumer only obtains a sharable merchandise sharing code after purchasing and acquiring the product, so as to ensure the product shared by a consumer is indeed purchased by the consumer, and to reduce the possibility of abusive sharing of the product. Further, a consumer shares a purchase website to another potential consumer by a simple operation of scanning the merchandise sharing code with a personal mobile apparatus, hence promoting the willingness of a consumer for sharing the product and achieving the object of sharing good things with good friends, while increasing the amount of sales of the product, creating multi-win effects for consumers and providers.

### BRIEF DESCRIPTION OF THE DRAWINGS

FIG. 1 is a diagram of a system structure according to a preferred embodiment of the present invention;

FIG. 2 is a schematic diagram of a product according to a preferred embodiment of the present invention;

FIG. 3 is a schematic diagram of a sharing operation according to a preferred embodiment of the present invention;

FIG. 4 is a schematic diagram of a product according to another preferred embodiment of the present invention;

FIG. 5 is a flowchart of operation method implementing a merchandise sales system of the present invention; and

FIG. 6 is a schematic diagram of profit sharing of the present invention.

### DETAILED DESCRIPTION OF THE PREFERRED EMBODIMENTS

Details and technical contents of the present invention are given with the accompanying drawings below.

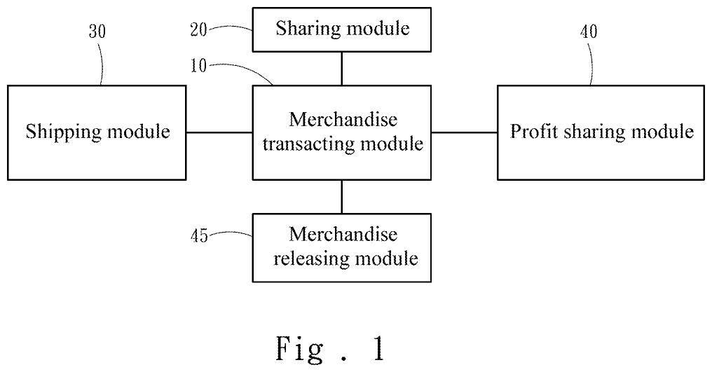

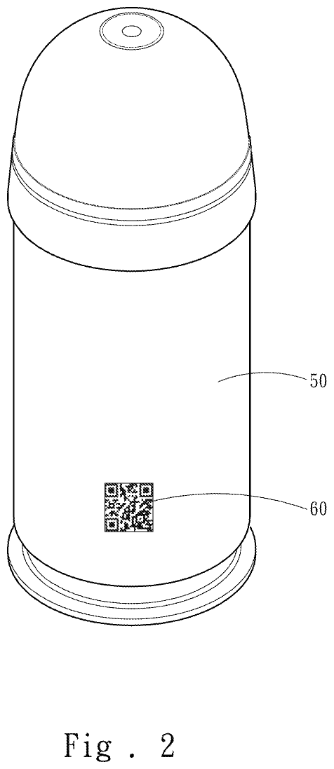

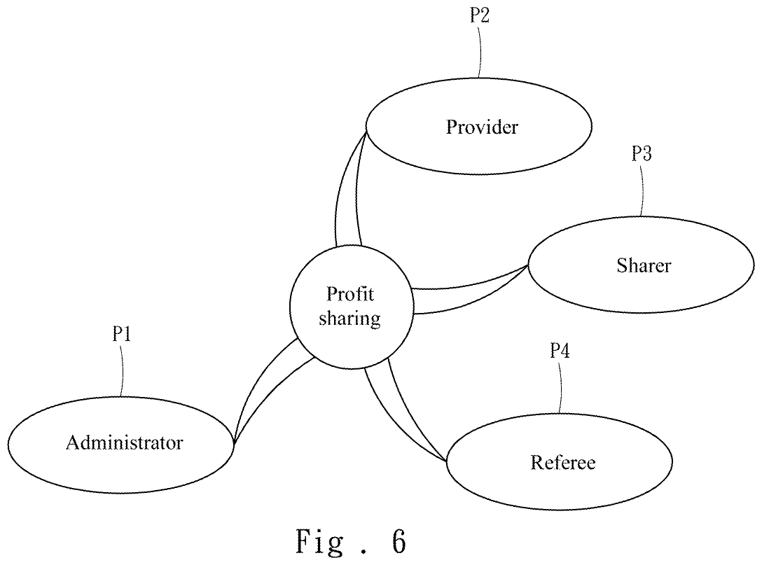

FIG. 1 and FIG. 2 show a diagram of a system structure and a schematic diagram of a product according to a preferred embodiment of the present invention. As shown in FIG. 1 and FIG. 2, the present invention provides a merchandise sales system for a consumer to selectively purchase a plurality of products 50, wherein the plurality of products 50 are shipped by a provider P2 (as shown in FIG. 6). The merchandise sales system includes a merchandise transacting module 10, a sharing module 20, a shipping module 30 and a profit sharing module 40. The merchandise transacting module 10 comprises a plurality of product items corresponding to the plurality of products 50, and generates a shipping message after the consumer selectively purchases one of the plurality of product item. For example, the product 50 is a storage container as shown in FIG. 2. In actual implementation, the merchandise transacting module 10 provides a transaction website, wherein the transaction website allows the consumer to browse through the plurality of product items. After the consumer selects one of the plurality of product items, the consumer directly fills information such as, for example but not limited to, recipient information and payment information, on the transaction website. The transaction website then returns related information to the merchandise transacting module 10 for generating the shipping message.

The sharing module 20 is connected to the merchandise transacting module 10. After the consumer selectively purchases the product item, the merchandise transacting module 10 notifies the sharing module 20 to allow the sharing module 20 generating a merchandise sharing code 60 for the purchased product item. The merchandise sharing code 60 comprises a purchase website including an identification code, that is, the identification code is a part of the purchase website. Since the identification code is available for identity recognition, the identification code is linked to the consumer who purchased the product item. Besides, the purchase website is directed to the transaction website, and the merchandise sharing code 60 is acquired by the consumer along with the product 50. The merchandise sharing code 60 is a one-dimensional barcode or a two-dimensional barcode, e.g., a Code 39 barcode, an interleaved two of five (ITF) barcode, a global trade item number-13 (GTIN-13) barcode, a quick response (QR) code, a portable data file (PDF) 417 barcode, or a composite barcode; the merchandise sharing code 60 shown FIG. 2 is a QR code. The identification code is unique and is linked to the consumer who purchased the product item, so as to avoid the issue of abusive sharing.

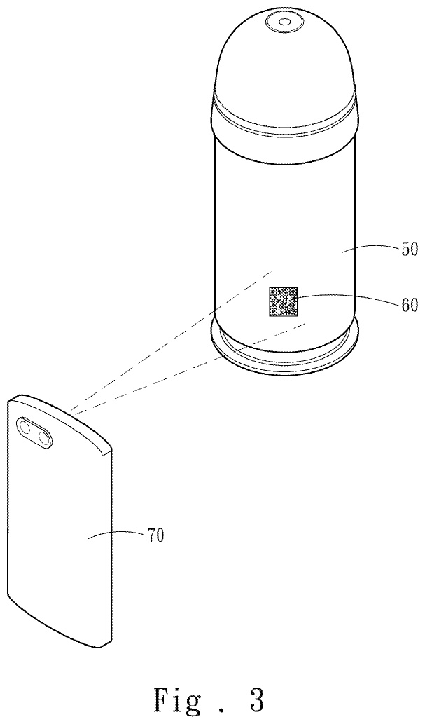

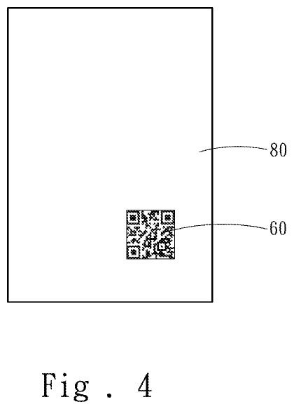

Again referring to FIG. 3, the shipping module 30, connected to the merchandise transacting module 10, receives the shipping message and provides the shipping message to the provider P2, so that the provider P2 is able to ship according to the shipping message and deliver the corresponding product 50 to the consumer. After the consumer acquires the merchandise sharing code 60, the merchandise sharing code 60 is scanned by a personal mobile apparatus 70 so as to share the purchase website to another potential consumer. It should be noted that, the merchandise sharing code 60 is directly printed on the product 50, i.e., the merchandise sharing code 60 is pre-loaded on the product 50, and the sharing module 20 merely binds the merchandise sharing code 60 with the consumer. As such, after the consumer acquires the product 50, the merchandise sharing code 60 is at the same time acquired. In another implementation, referring to FIG. 4, the merchandise sharing code 60 is printed on a paper material 80, which applies to the type that the product 50 is unsuitable to be directly printed the merchandise sharing code 60 thereon. Further, the paper material 80 is combined with an instruction manual and a warranty card to save the use of paper.

Further, the consumer shares the purchase website with another potential consumer by scanning the merchandise sharing code 60 with the personal mobile apparatus 70. The sharing module 20 generates an inform message to notify the consumer to share the merchandise sharing code 60 on a social website or a communication software with personal mobile apparatus 70.

The personal mobile apparatus 70 is a smartphone, a tablet computer or other portable smart information apparatuses. The social website includes Facebook, Google+, Myspace, Plurk, Twitter, WeChat and Microblog. The communication software includes LINE, Facebook Messenger, WhatsApp, WeChat, and M+Messenger.

The profit sharing module 40 is connected to the merchandise transacting module 10. When the merchandise transacting module 10 detects that another potential consumer enters the transaction website through the purchase website and purchases the product item, the merchandise transacting module 10 transmits the identification code included in the purchase website to the profit sharing module 40. According to the identification code, the profit sharing module 40 rebates a cashback amount according to the identification code to the consumer linked to the identification code.

Since the identification code included in the merchandise sharing code 60 is unique, the merchandise transacting module 10 easily learns and determines whether another potential consumer enters the transaction website and purchases the product item through the merchandise sharing code 60 shared by the consumer. Thus, when the profit sharing module 40 rebates the cashback amount according to the identification code to the consumer who purchased the product item, an issue of erroneously rebating or missing the rebate of the cashback amount is avoided.

Further, to increase the variety of the plurality of product items and to boost the purchase choice for the consumer, the present invention further includes a merchandise releasing module 45. The merchandise releasing module 45, connected to the merchandise transacting module 10, is provided for a referee P4 (shown in FIG. 6) to recommend a new product. The referee P4 provides the new product information for examination, and the merchandise releasing module 45 allows the new product being a part of the plurality of products 50 once the new product passes the examination. The new product information includes, for example but not limited to, product resume, provider, quality and product description. In the presence of the referee P4 referring the product, the profit sharing module 40 further rebates a referral cashback amount according to the identification code to the corresponding referee P4 so that provide the consumer and the provider P2 with an incentive in applying to act as the referee P4.

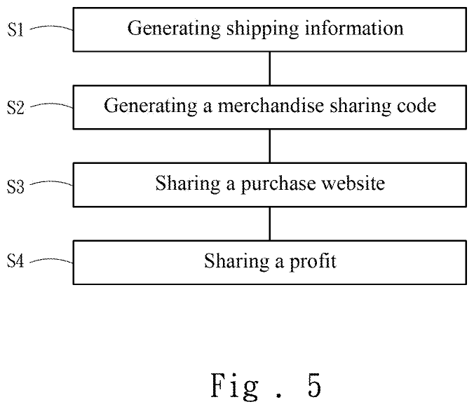

FIG. 5 shows a flowchart of the operation method of the merchandise sales system of the present invention. Referring to FIG. 5, the process steps are as follows.

step S1, generating shipping information; step S2, generating a merchandise sharing code 60; step S3, sharing a purchase website; and step S4, sharing a profit. First, Step S1 of generating the shipping information is performed. In step S1, after the consumer purchases one of the plurality of product items on the transaction website, the merchandise transacting module 10 generates the shipping message, wherein the shipping message includes, for example but not limited to, the product item and quantity purchased by the consumer and shipping address.

Step S2 of generating the merchandise sharing code is then performed. In step S2, the merchandise transacting module 10 notifies the sharing module 20 generating the merchandise sharing code 60. When the sharing module 20 generates the merchandise sharing code 60, the sharing module 20 generates an inform message to notify the consumer to share the merchandise sharing code 60 on a social website or a communication software with personal mobile apparatus 70. The merchandise sharing code 60 is preset in advance on the product 50. The sharing module 20 binds the merchandise sharing code 60 with the consumer who purchasing the product item, such that the merchandise sharing code 60 is exclusive to the consumer. If the merchandise sharing code 60 is directly printed on the paper material 80, the sharing module 20 then generates the merchandise sharing code 60 after the consumer purchases the product item, and directly print the merchandise sharing code 60 on the paper material 80 for shipping altogether.

Next, step S3 of sharing the purchase website is performed. In step S3, the merchandise transacting module 10 provides the shipping message to the provider P2 for delivering the corresponding product 50 along with the merchandise sharing code 60 to the consumer, so as to allow the consumer who acquired the merchandise sharing code 60 to share the purchase web site by scanning the merchandise sharing code 60 by the personal mobile apparatus 70.

Step S4 of profit sharing is at last performed. In step S4, the merchandise transacting module 10 continuously detects whether another potential consumer enters the transaction website through the purchase website and purchases the product item. When another potential consumer enters the transaction web site through the purchase web site and purchases the product item, the merchandise transacting module 10 transmits the identification code included in the purchase website to the profit sharing module 40. According to the identification code, the profit sharing module 40 rebates the cashback amount to the consumer linked to the identification code.

Referring to FIG. 6, the merchandise sales pattern of the present invention at most includes four participants, which are an administrator P1 of the merchandise sales system, a provider P2, a sharer P3 (consumer) and a referee P4. In other words, the benefit generated from selling the product 50 in the present invention is shared by these four participants, and the ratio of profit sharing is configured as desired according to the attribute of the product 50. Under the mode of the system, the administrator P1 of the merchandise sales system primarily provides the system for utilization, maintains the operation of the system, and processes cash flows of selling the product 50 and profit sharing, but does not directly intervene in the production and promotion of the product 50; the provider P2 is in charge of production, shipping and warranty of the product 50 only; the sharer P3 (consumer) is in charge of a trial, introduction and promotion of the product 50; the referee P4 is in charge of developing and releasing new products. As such, the four participants provide mutual assistance and mutual supervision, so as to complete the sales of the product 50 within the shortest period possible, achieving smooth merchandise flow and satisfying application requirements of commercial sales.

In conclusion, the merchandise sales system and the operation method thereof provided by the present invention includes at least the following features:

1. After a consumer purchases and acquires a product, a sharable merchandise sharing code is acquired, hence ensuring the product shared by a consumer is indeed purchased by the consumer, and significantly reducing the possibility of abusive sharing of a product.

2. A consumer shares a purchase website to another potential consumer by a simple operation of scanning a merchandise sharing code by a personal mobile apparatus, thus boosting the willingness of a consumer for sharing a product, achieving the object of sharing good things with good friends.

3. With the design of profit sharing, sales channels of a product are expanded to achieve increased sales amount, creating multi-win effects for consumers and providers.

What is claimed is:

1. A merchandise sales system, for a consumer to selectively purchase a plurality of products, the plurality of products shipped by a provider, the merchandise sales system comprising:
a merchandise transacting module, comprising a plurality of product items corresponding to the plurality of products, and the merchandise transacting module generating a shipping message after the consumer selectively purchases one of the plurality of product items;
a sharing module, connected to the merchandise transacting module, and notified by the merchandise transacting module after the consumer purchases the product item to generate a merchandise sharing code for the purchased product item, wherein the merchandise sharing code includes a purchase website comprising an identification code, the identification code is linked to the consumer who purchased the product item, the purchase website is directed to a transaction web site, and the merchandise sharing code is acquired by the consumer along with the product;
a shipping module, connected to the merchandise transacting module, and the shipping module receiving the shipping message and providing the shipping message to the provider, so as to ship according to the shipping message and deliver the corresponding product to the consumer, wherein after the consumer acquires the merchandise sharing code, the purchase web site is able to be shared by the consumer to another potential consumer by scanning the merchandise sharing code with a personal mobile apparatus; and
a profit sharing module, connected to the merchandise transacting module, wherein when the merchandise transacting module detects that another potential consumer enters the transaction website through the purchase website and purchases the product item, the merchandise transacting module transmits the identification code comprised in the purchase website to the profit sharing module, and the profit sharing module rebates a cashback amount according to the identification code to the consumer linked to the identification code.

2. The merchandise sales system of claim 1, further comprising:
a merchandise releasing module, connected to the merchandise transacting module, and provided for a referee to recommend a new product, wherein the referee provides product information of the new product for examination, and the merchandise releasing module allows the new product being a part of the plurality of products after the new product passes the examination.

3. The merchandise sales system of claim 2, wherein the profit sharing module further rebates a referral cashback amount according to the identification code to the corresponding referee.

4. The merchandise sales system of claim 1, wherein the merchandise sharing code is directly printed on the plurality of products.

5. The merchandise sales system of claim 1, wherein the merchandise sharing code is printed on a paper material.

6. The merchandise sales system of claim 1, wherein the sharing module is configured to generate an inform message to notify the consumer to share the merchandise sharing code on a social website with the personal mobile apparatus.

7. The merchandise sales system of claim 1, wherein the sharing module is configured to generate an inform message to notify the consumer to share the merchandise sharing code on a communication software with the personal mobile apparatus.

8. An operation method of the merchandise sales system of claim 1, comprising:
step S1: generating shipping information; the merchandise transacting module generating the shipping message after the consumer purchases one of the plurality of products on the transaction website;
step S2: generating a merchandise sharing code; the merchandise transacting module notifying the sharing module to generate the merchandise sharing code;
step S3: sharing the purchase website; the merchandise transacting module providing the shipping message to the provider so as to deliver the corresponding product to the consumer and have the merchandise sharing code be acquired by the consumer along with the product; wherein after the consumer acquires the merchandise sharing code, the purchase website is shared by the consumer to another potential consumer by scanning the merchandise sharing code with the personal mobile apparatus; and
step S4: sharing a profit; the merchandise transacting module continuously detecting whether another potential consumer enters the transaction website through the purchase website and purchases the product item, and when the potential consumer enters the transaction website through the purchase web site and purchases the product item, the merchandise transacting module transmitting the identification code comprised in the purchase website to the profit sharing module, allowing the profit sharing module to rebate a cashback amount according to the identification code to the consumer linked to the identification code.

9. The operation method of claim 8, wherein the merchandise sales system further comprise a merchandise releasing module which is connected to the merchandise transacting module, the merchandise releasing module is provided for a referee to recommend a new product, wherein the referee provides product information of the new product for examination, and the merchandise releasing module allows the new product being a part of the plurality of products after the new product passes the examination.

10. The operation method of claim 9, wherein the profit sharing module further rebates a referral cashback amount according to the identification code to the corresponding referee.

11. The operation method of claim 8, wherein the merchandise sharing code is directly printed on the product.

12. The operation method of claim 8, wherein the merchandise sharing code is printed on a paper material.

13. The operation method of claim 8, wherein in step S2, the sharing module generates an inform message to notify the consumer to share the merchandise sharing code on a social website with the personal mobile apparatus.

14. The operation method of claim 8, wherein in step S2, the sharing module 20 generates an inform message to notify the consumer to share the merchandise sharing code on a communication software with the personal mobile apparatus.
